(19) United States
(12) Patent Application Publication
(10) Pub. No.: US 2022/0245608 A1
(43) Pub. Date: Aug. 4, 2022

(54) METHODS AND APPARATUS FOR QUANTIFYING A PHYSICAL TRANSACTION WITH A NON-FUNGIBLE TOKEN

(71) Applicant: Nice Frog, LLC, Greenwich, CT (US)

(72) Inventor: James D. Burchetta, Greenwich, CT (US)

(73) Assignee: Nice Frog, LLC, Greenwich, CT (US)

(21) Appl. No.: 17/725,541

(22) Filed: Apr. 20, 2022

Related U.S. Application Data
(63) Continuation-in-part of application No. 16/599,851, filed on Oct. 11, 2019, now abandoned.
Application No. 16/599,851 is a continuation-in-part of application No. 14/707,364, filed on May 8, 2015, now abandoned.
(60) Provisional application No. 61/991,610, filed on May 11, 2014.

(51) Int. Cl. G06Q 20/12; G06Q 30/06; H04W 4/80

(52) U.S. Cl. CPC G06Q 20/1235; G06Q 30/0619; H04W 4/80; G06Q 30/0641; G06Q 30/0639

(57) ABSTRACT

Methods and apparatus for safely and securely initiating communications about an item in a physical environment that is linked to a virtual item associated with e non-fungible token (NFT) in a virtual world. A unique identifier is linked to the NFT in the virtual world and a Bluetooth Low Energy (BLE) beacon in a tag in the physical world. More particularly, the present disclosure relates to utilizing a BLE-enabled tag as an indication of availability and, based on a user's proximity to the BLE tag, as a means for a second party to show interest in acquiring the NFT and the physical item without requiring an exchange of personal information.

### CROSS-REFERENCE TO RELATED APPLICATION

This application claims priority to and the full benefit of U.S. Non-Provisional application Ser. No. 16/599,851 filed Oct. 11, 2019 and titled METHODS AND APPARATUS FOR INITIATING COMMUNICATION BETWEEN PARTIES USING A BLUETOOTH LOW ENERGY BEACON which claims priority to U.S. Non-Provisional application Ser. No. 14/707,364, filed May 8, 2015 and titled “METHODS AND APPARATUS FOR INITIATING COMMUNICATION BETWEEN PARTIES”, which itself claims priority to U.S. Provisional Patent Application Ser. No. 61/991,610, filed May 11, 2014, and titled “METHODS AND APPARATUS FOR INITIATING COMMUNICATION BETWEEN PARTIES,” the entire contents of both of which are incorporated herein by reference.

### FIELD OF DISCLOSURE

This disclosure relates to methods and apparatus for safely and securely initiating communication between parties. More particularly, the present disclosure relates to utilizing a logo as an indication of availability and as a means for a second party to show interest without requiring an exchange of personal information.

### BACKGROUND

Traditionally, when a party wanted to place a good on the market, such as a car or a property, the party placed an ad in a newspaper or posted signs on or near the product. The ad or signs would likely contain some personal contact information, which would allow an Interested Party to contact the seller. The parties would then arrange to meet and discuss the terms of the sales, and if the terms were agreeable to both parties, they may conduct a transaction.

More recently, websites embody a virtual “Want Ad” formerly seen in printed publications. For example, websites such as Craigslist or eBay allow sellers to reach a broader audience and, in some cases, provide a secure payment platform. However, the transactions still typically involve some exchange of personal information and/or a risky meeting arrangement.

In addition, according to traditional methods of marketing and exchange, a car or other property needed to be actively listed and offered sale. A potential customer would need to access a DMV or property records in order to ascertain an owner of a car or property not listed for sale.

Moreover, traditional methods of online sales may not be tailored to a consumer's specific needs. Most important of these needs is generally geographic—a car that is on sale two miles from the consumer's residence is likely of more interest than a car that is on sale two thousand miles from the consumer's residence.

And such online interactions require a significant amount of effort to search through. Consumers likely need to run iterated searches over a long period of time to finally find the product they want.

What is needed therefore is a convenient, safe, and effective way to convey availability of a product and a responsive interest in the product, including conveying spatial proximity to the product.

### SUMMARY

Accordingly, the present disclosure provides a systems with methods and apparatus for utilizing a logo as an indication of availability and as a means for a second party to show interest without requiring an exchange of personal information in one or both of a physical world and a virtual world. The system is useful in the conveyance of a physical item in the physical world and a unique digital token in a virtual world, such as a metaverse The present disclosure also provides for push notifications sent to either or both of the first and second party when the logo is in close spatial proximity to either party.

Embodiments of the present disclosure may include a tag capable of facilitating communication between a first party and a second party with a tag that includes a transceiver. A power source provides electrical energy to the transceiver. Embodiments may also include a network access device in logical connection with a communications network to allow communication with a server.

Software may be operable to receive a first unique identifier from the tag. Embodiments may also include associate the first unique identifier with a non-fungible token (NFT) in a virtual world. Embodiments may also include associate the first unique identifier with an item in the physical world. Embodiments may also include receive a second unique identifier from the first party.

Embodiments may also include compare a user profile associated with the first party with a tag profile associated with the second party. Embodiments may also include upon determination of a match between the user profile and the tag profile, transmit a signal to the first party or the second party to initiate a communication between the first party and the second party. Embodiments may also include receive an instruction from the first party to transfer one or both of ownership and control of the NFT in the virtual world, and the item in the physical world to an entity designated by the second party to receive the one or both of the NFT in the virtual world, and the item in the physical world.

In some embodiments, the tag profile may include information associated with an available product, service, or a person. A second party may be associated with the available product, service, or person in both a physical world and a virtual world. An NFT may be associated with one or more of the person, product and service.

Some variants of the present disclosure may include a method for initiating communication between a first party and a second party based on receipt of a wireless transmission, the method including the steps of transmitting a tag identifier via a wireless transceiver from a tag to a smart device associated with the first party. Embodiments may also include associating the tag identifier with a non-fungible token (NFT).

Some variants may also include accessing a server including a server memory. In some embodiments, the server memory contains a tag profile associated with the second party and a user profile associated with the first party and the NFT. Embodiments may also include receiving into the tag a user identifier associated with the first party.

Some variants may also include transmitting from the tag the user identifier and the tag identifier. Embodiments may also include comparing the tag profile with the user profile. Embodiments may also include upon confirmation of a match of predefined parameters of the tag profile and the user profile, transmitting information to the smart device. Embodiments may also include transferring the NFT.

Also, one or both of the first and second parties may indicate a desired communication medium in one or both of a virtual world and a physical world. Embodiments may also include initiating a communication utilizing the indicated communication medium, such as a text message.

In an additional embodiment, a remote computer server may send a “push” notification to a user's phone based on proximity to a Tag, and optionally based on pre-designated interests in a profile. The proximity may be based on any of: Bluetooth, Bluetooth Low Energy (BLE), GPS, or internal dead-reckoning.

The details of one or more examples of the disclosure are set forth in the accompanying drawings and the description below. The accompanying drawings that are incorporated in and constitute a part of this specification, illustrate several examples of the disclosure and, together with the description, serve to explain the principles of the disclosure: Other features, objects, and advantages of the disclosure will be apparent from the description, drawings and the claims herein.

### DESCRIPTION OF THE DRAWINGS

The foregoing and other features and advantages of the disclosure will be apparent from the following, more particular description of preferred examples of the disclosure, as illustrated in the accompanying drawings.

FIG. 1A illustrates an exemplary embodiment of a logo affixed to a building, wherein the logo may be indicative of property availability.

FIG. 1B illustrates an exemplary embodiment of a logo affixed to a shop, wherein the logo may be indicative of product availability within the shop.

FIG. 1C illustrates an exemplary embodiment a logo affixed to a bumper of a vehicle, wherein the logo may indicate that the car may be for sale.

FIG. 1D illustrates an exemplary embodiment including wearable tags, wherein the tag may be indicative of availability.

FIG. 2A illustrates an exemplary embodiment of a logo.

FIG. 2B illustrates an alternate exemplary embodiment of a logo.

FIG. 3 illustrates an exemplary system for accessing product information of an available product.

FIG. 4 illustrates an exemplary system for receiving identification information of an available product.

FIG. 5 illustrates an exemplary system for accessing product information of multiple available products.

FIG. 6 illustrates an exemplary processing and interface system.

FIG. 7 illustrates exemplary method steps for wirelessly receiving profile information, wherein the identification information may be received through a wireless transmission from a tag on a logo.

FIG. 8 illustrates exemplary method steps for wirelessly receiving profile information, wherein the identification information may be retrieved through capture of a code or image of a logo.

FIG. 9 illustrates exemplary method steps for initiating direct communication between a profile owner and an Interested Party.

FIG. 10 illustrates exemplary method steps for transmitting profile information to an external device.

FIG. 11 illustrates exemplary method steps for allowing direct communication between a profile owner and an Interested Party.

FIG. 12 illustrates exemplary method steps for initiating a communication based on a Bluetooth Low Energy interaction.

FIG. 13 illustrates a schematic diagram of components included in some embodiments of the present invention.

FIG. 14 illustrates a block diagram of components included in some embodiments of the present invention.

FIG. 15 illustrates exemplary method steps that may be practiced in some variants of the present invention.

FIG. 16 illustrates additional exemplary method steps that may be practiced in some variants of the present invention.

### DETAILED DESCRIPTION

The present disclosure relates generally apparatus and systems for facilitating communications between parties in a manner controlled by one or both parties in both a physical world environment and a virtual world environment. Generally, a user operates a smart device, such as a smart phone or tablet to transmit a unique identifier affixed to a communications subject. The smart phone will then receive back information relating to the item and to a virtual world unique token, such as a non-fungible token (NFT). Associated processes may also be used to communicate to a person associated with the communications subject. Some examples may include the person associated with the item communicating directly to the user in one or both of the physical world and the virtual world about conveyance of one or both of a physical item and a NFT associated with the physical item (and in some preferred embodiments, descriptive of the physical item).

### Glossary

As used herein the following terms will have the following associated meanings:

Available: as used herein describes a person or product that may be available for purchase or sale on a market. For example, an available product may be on the market for purchase, sale, rent, lease, or other means of conveyance. Similarly, an available person may be on the market for socializing, dating, or hiring, for example.

Bluetooth Low Energy (BLE): as used herein refers to a wireless personal area network technology designed and marketed by the Bluetooth Special Interest Group.

Communications subject: as used herein refers to a person or object to which a tag is attached.

Interested Party: as used herein refers to an individual, company, or group that may be in interested in a particular product, service or person that they have seen or have accessed data associated with that product, service or person.

Logo: as used herein refers to an image that indicates availability of a good or person, and wherein the image further comprises a unique identification medium, such as Bluetooth beacon or code, such as a QR or bar code.

Non-Fungible Token: (sometimes referred to as an “NFT”) as used herein shall mean a unique digital token recorded in a digital ledger, such as a blockchain ledger.

Prospective Party: as used herein refers to individuals, companies, or groups that may potentially be interested in a particular product, service or person if and when the prospective party is made aware of the particular product, service or person.

Tag: as used herein refers to a detectable marker that may be embedded in a logo or may be attached separately to an available good or person. In some examples, a Tag may comprise embedded information detectable though Radio Frequency Identification (RFID), Bluetooth, including BLE or Wi-Fi, as non-limiting examples.

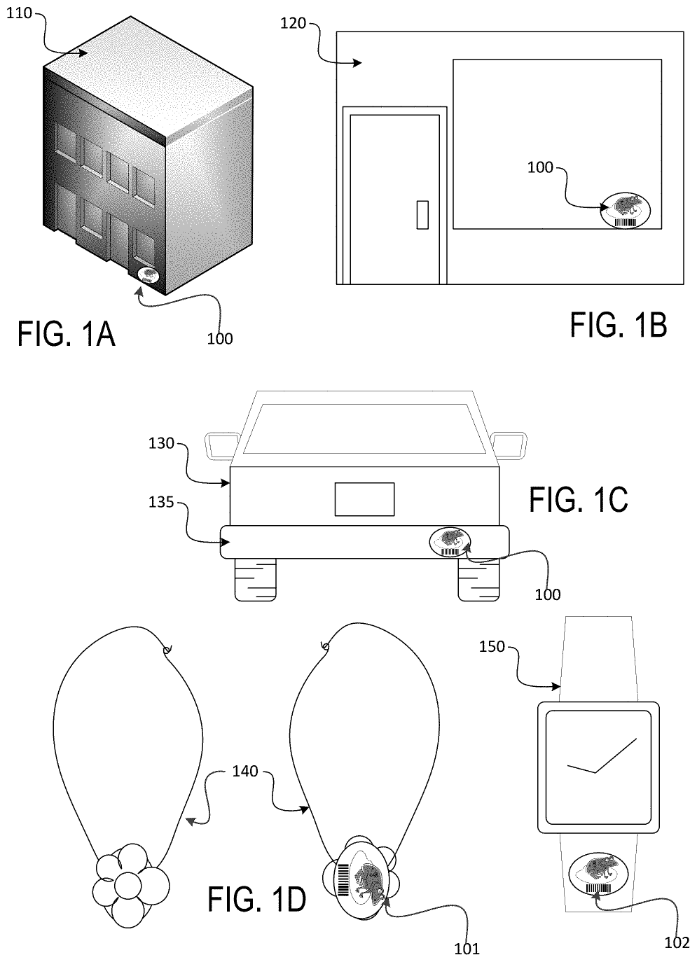

Referring now to FIG. 1A, an exemplary embodiment of a Tag 100 affixed to a building 110, wherein the logo may be indicative of property availability, is illustrated. In some examples, the Tag 100 may indicate that the entire building 110 is for sale or lease. In other examples, the Tag 100 may indicate that a portion of the building 110 may be available for sale, rent, or lease. For example, a building 110 may comprise multiple office spaces, apartment, or parking spaces, which may be sold, rented, or leased separately. There may be other aspects of the building that may be associated with an attached logo of the type indicated at 100.

Referring now to FIG. 1B, an exemplary embodiment of a tag embedded in a Tag 100 affixed to a shop 120, wherein the Tag 100 may be indicative of product availability within the shop 120, is illustrated. In some examples, the Tag 100 may be placed in a location visible from the exterior of the shop 120, which may allow potential interested parties to view product availability outside of normal operating hours of the shop 120. In subsequent steps, the potential Interested Party may signal there interest in the products or services of the shop 120.

Referring now to FIG. 1C, an exemplary embodiment of a Tag 100 affixed to a bumper 135 of a vehicle 130, wherein the Tag 100 may indicate that the vehicle 130 may be for sale, is illustrated. In some examples, the Tag 100 may be affixed to a window, which may allow for easier visibility and image capture access for potential interested parties. In some other examples, the Tag 100 may represent a service that is offered by the operator of the vehicle 130. There may be numerous products, services or people that may be associated with the placement of the Tag 100 on a vehicle 130.

In some examples, a car dealership may utilize removable tags 100 on their available inventory, wherein the Tag 100 may be removed once the vehicle has been sold or leased. Data for the car may be linked to its adhered tag. In such examples, an Interested Party may receive communication from the Tag 100 and receive information about the vehicle based upon the Interested Party's profile indicating and desire to receive such information, evaluate the vehicle features, and determine what offer, if any, may be reasonable.

Examples may also include a designated location and date and time for vehicles, or other items identified by a Tag 100 to be displayed. For example, the present disclosure enables a hybrid physical/virtual swap meet to take place at a designated venue. Vehicles may be brought to a venue on a designated day and potential customers may peruse the vehicles identified via a Tag 100. If the potential customer desires additional information, such as the year, model, specifications, miles and other associated information, the user may wirelessly receive information from the Tag 100 and use the wirelessly received information to access related information on a website associated with the logo listing.

Referring now to FIG. 1D, examples of wearable Tags 101-102, wherein the Tags 101-102 may be indicative of availability, are illustrated. In some examples, the Tags 101-102 may comprise a logo, an RFID or Bluetooth transceiver, which may be detectable by portable mobile devices, such as, smartphones or tablets. In some examples, such Tags 101-102 may be paired with a social network profile or a profile specific to an event, such as a conference or symposium. For example, a wearer may pair earrings 140 or a watch 150 to a dating website, wherein the wearer may only detect and be detectable to other members of the dating site. The wearer may limit the area of detection, for example, to a distance or one meter or less from the wearer or alternatively to a larger area. The wearer may limit the functionality of the tag to a geographical region such as in these non-limiting examples, an area of town, a particular venue, or an event. The wearer may indicate availability via a wearer profile.

Other examples include wearing a nametag with a Tag fixed to the nametag to a conference or symposium or other event. The Tags 101-102 may be associated with a conference sponsor or other party. The nametag will include a link to a website including additional information about the person wearing the name tag, or other information the person wearing the name tag may wish to communicate.

By way of non-limiting example, a person at a symposium, conference or other organized event may wear a Tag 101-102 and another event attendee may scan the tag via receipt of a wireless transmission from the Tags 101-102. The information associated with the Tags 101-102 may relate directly to the person wearing the tag, or to and organization or topic the person wearing the tag wishes to convey information on.

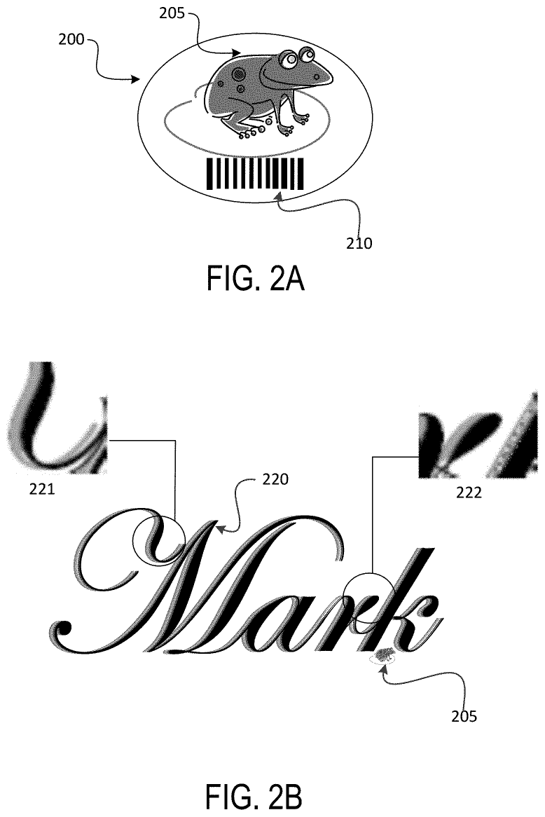

Referring now to FIGS. 2A and 2B, examples of a logo are illustrated. In some examples, as shown in FIG. 2A, the logo 200 may comprise an image 205 and, in some embodiments, a separate identification code 210, such as a bar code identification or QR code (though a BLE transceiver serving as a beacon may be preferable). In some examples, the logo at 200 may be associated with a particular company that offers application software, services and/or hardware associated with the types of examples that are described herein. Alternatively, such as shown in FIG. 2B, a company or user may utilize their own mark as a base image for the identification device. The user's mark may be altered in subtle ways that may embed an identification code into their mark 220, wherein the coding may not distract from the company mark 220. In some examples, a company may embed image differences that provide encoding into their logo, wherein the logo may comprise at least one coded portion 222, in contrast to a non-coded portion 221.

The image differences may be extracted through an algorithm which accesses a standard image version of the user's logo and compares the differences of the captured image with the standard logo image. The algorithm may be performed with a computing device, which may be integrated into the mobile reader device, such as a smartphone, tablet, or laptop. The presence of a small version of a provider's logo image 205 may support application software in determining whether a given logo image should contain an encoded portion that may contain a unique identifier. In some examples, the image may comprise redundant sets of coded portions 222, which may increase reader reliability.

In some examples, the image 205 may indicate that the associated person or product participates in the communication program, and the image 205 may be integrated into the company mark 220 to notify prospective parties that the mark 220 may be scanned. In some examples, the image 205 may be situated similarly to a “TM” that indicates a trademark, wherein the image 205 may be apparent but identifiable as separate from the company mark 220.

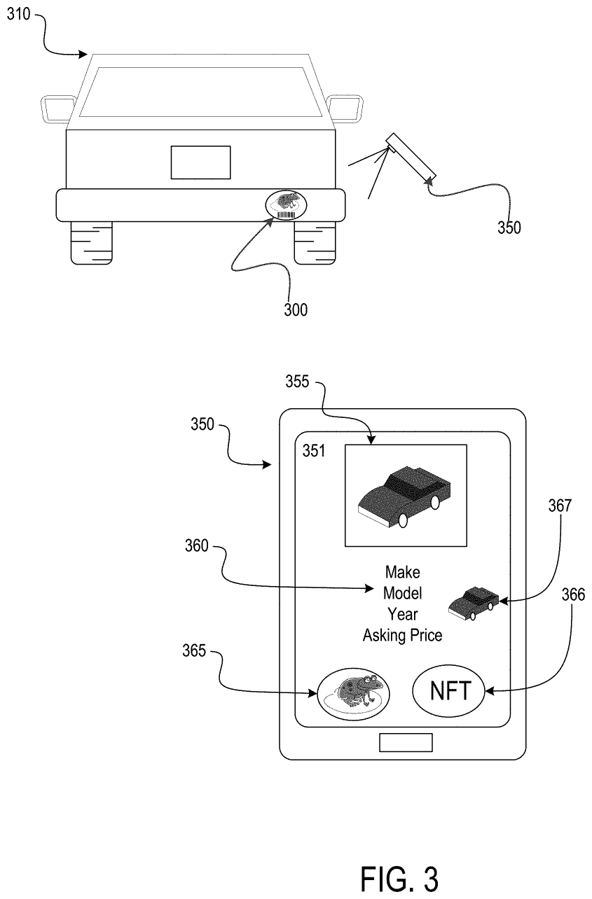

Referring now to FIG. 3, an exemplary system for accessing product information of an available product is illustrated. In some examples, a logo 300 may be affixed to the bumper of a vehicle 310, and an Interested Party may scan or capture the logo 300 utilizing a mobile device 350, such as a smartphone. In a non-limiting example, the smartphone may be used as a camera to collect a camera image of the identification device. In some examples, the mobile device 350 may be used in part of a process to retrieve information associated with the product profile and present it to the Interested Party. For example, the mobile device 350 may present an interactive user interface 351 that includes photograph 355 and specifications 360 of the vehicle 310. The mobile device 350 may allow the Interested Party to initiate an offer or to find more information, for example, by selecting a functional icon 365, which may trigger a secure communication to the seller.

The secure communication may or may not require nor include personal information from either party as implemented in a given implementation, wherein communication may occur through a secondary network. For example, the method of communication between the parties may be texting, but the texting may not occur directly between the phone numbers. In some embodiments, the provider of the identification related services described herein may provide temporary, anonymous user-ids, and the like to allow for communication through various channels including in a non-limiting sense, email, chat, text, social media or other such means.

In some examples, an Interested Party may scan a logo with a scanning device, such as a mobile phone or a tablet. The scanning device may transmit the captured logo to a server over a network, wherein the server may access a database and transmit the product information associated with the captured logo. The Interested Party may review the product information and determine if they may want to show interest. In some examples, the Interested Party may show interest by making an offer on the product, wherein the offer may comprise proposed terms, such as price or lease period.

Upon consummation of a transaction transferring one or both of ownership and control of the physical item in the real world, a transfer of a NFT 367 may be completed via activation of a user interactive device 366 operative to transfer the NFT 367.
According to some embodiments, of the present invention an NFT is a one-of-a-kind digital token created (or “minted”) and recorded on a digital ledger, called a blockchain. NFTs can be bought and sold like any other property, but they have no physical form. NFTs are “non-fungible” (i.e., unique and not interchangeable) because each token comprises unique data (e.g., code and other metadata) that distinguishes it from other NFTs relating to the relevant blockchain. Blockchain solutions like the public Ethereum network, Polkadot, Cosmos and Flow can be used to create NFTs. The NFTs can then be bought and sold via an NFT marketplace website that is linked to the underlying blockchain solution (e.g., OpenSea). According to the present invention the buying and selling of a NFT 367 may be tied to the sale of a corresponding physical item 310. Furthermore, in some embodiments, the NFT may exist in a virtual world, such as a metaverse.

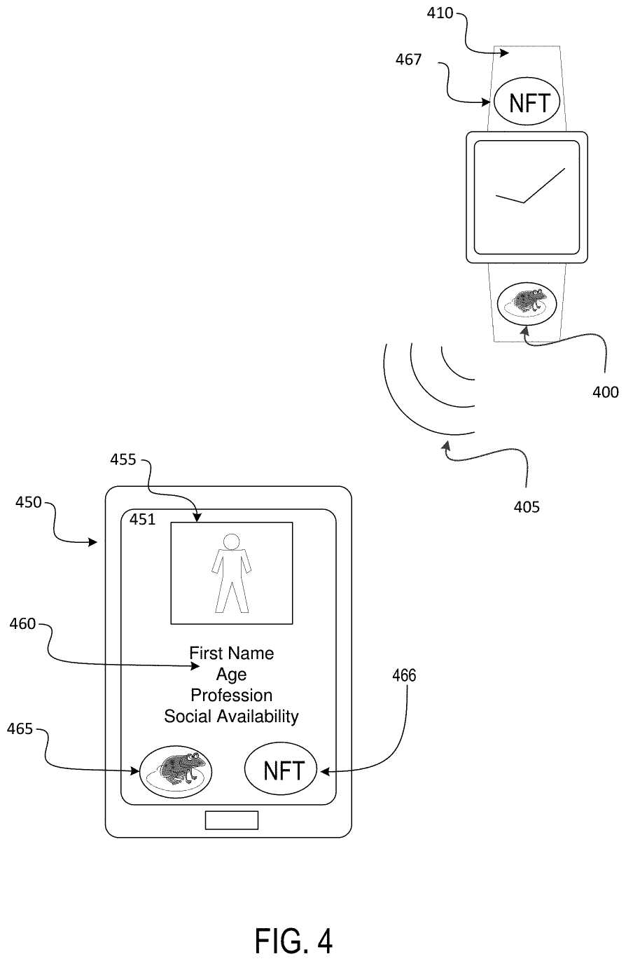

Referring now to FIG. 4, an exemplary system for accessing information for available persons is illustrated. In some examples, an available person may wear an item 410 on their person such as a watch. The item may include a logo 400 that may further comprise a tag, which may be wirelessly detectable by a mobile device 450, such as a smartphone, tablet, or laptop. In some examples, the tag may comprise an energized or energizable component, wherein the tag may be capable of wirelessly transmitting 405 identification information to the mobile device 450.

In some examples, the tag may comprise an energy source, such as a battery. In such examples, the energy source may be rechargeable, such as through solar power or energy harvesting. In other examples, the tag may be capable of accepting power, wirelessly or through a wired connection. For example, where a logo may be affixed to a building, the tag may be plugged into an outlet, similarly to a neon sign in a storefront window. Alternatively, a tag may comprise an antenna that may accept power from predefined reader devices. A mobile device 450 may be equipped with the transmitting technology, such as Bluetooth, or additional hardware may be necessary. For example, a dongle may be attached, which may transmit energy and/or receive the wireless transmission 405 of data.

In some examples, the mobile device 450 may receive the wireless transmission 405, and notify the prospective party that a tag has been detected. For example, the notification may comprise an audible, tactile, and/or visual alert. In some examples, the notification may prompt the prospective party to acknowledge the alert, or the notification may further include a snapshot of the data associated with the logo 400. For example, the mobile device 450 may present a photo 455 and profile information 460 of the available person. The prospective party may review the details and determine if they may want to show interest. The Interested Party may click on an interactive icon 465 included on a user interactive interface 451, which may, in some examples, initiate direct communication with the available person associated with the logo 400. For example, the direct communication may be a text, which may enable the available person to directly respond, without exchanging personal contact information.

In some embodiments, a NFT user interactive device 466 may be activated to cause executable software to be operative to transfer a NFT 467 associated with the item 410 worn by a physical world person. In some embodiments, the NFT 467 may correlate with a likeness of a person wearing the item 410, other embodiments may include the NFT correlating with a likeness of the item 410.

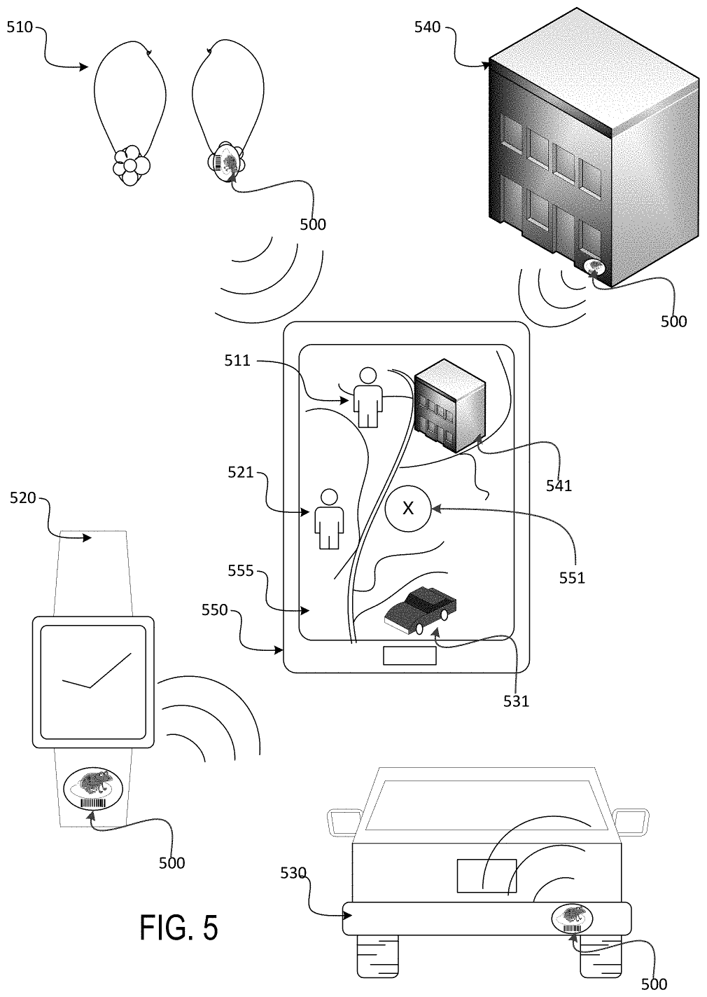

Referring now to FIG. 5, an exemplary system for accessing product information of multiple available products is illustrated.

A mobile device 550 may be able to detect a variety of product types or persons, or in other examples, the mobile device 550 may only detect a specific product type or person.

In some examples, the mobile device 550 may present detected products and persons to the prospective party simultaneously, such as through a map view 555. For example, the map view 555 may present a road map of the vicinity and indicate the prospective party position 551 on the map. Each detected available product, service or person may be indicated by category icons within the map. Such a presentation may allow for dynamic interfacing, which may be practical when one or more of the prospective party or available products or persons may be mobile.

As an illustrative example, a mobile device 550 may detect a woman wearing earrings 510 with a logo 500, a man wearing a watch 520 with a logo 500, a vehicle 530 with a logo 500 on its bumper, and a building 540 with a logo 500. The map view 555 may show two people icons 521, 511 for the man's watch 520 and the woman's earrings 510, respectively; a car icon 531 for the vehicle 530; and a building icon 541 for the building 540.

In some examples, a prospective party may set desired products and/or product attributes, which may allow their mobile computing device to passively detect and filter available products with tags. As an illustrative example, a prospective party may be searching for an SUV and an apartment, and his mobile device may detect six nearby tags: a building for sale; an apartment building with available apartments; a motorcycle for sale; a limousine for rent; an SUV for sale; and a person from a dating website. The device may filter the results and notify the prospective party only of the SUV and the apartment building listings.

The prospective party may investigate any of the available products or persons by physically going to their location or may select the appropriate icon to access their information. Where the prospective party becomes an Interested Party, the communication may be similar to that described in FIG. 3.

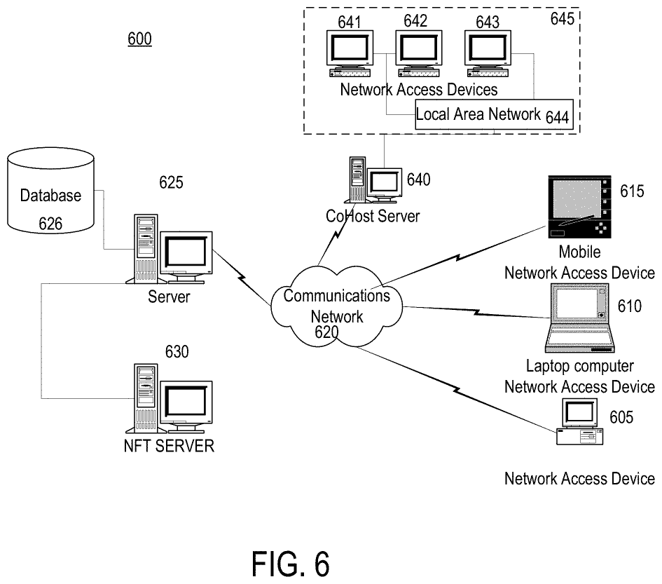

Referring now to FIG. 6, an exemplary processing and interface system 600 is illustrated. In some aspects, access devices 615, 610, 605, such as a mobile device 615 or laptop computer 610 may be able to communicate with an external server 625 though a communications network 620. The external server 625 may be in logical communication with a database 626, which may comprise data related to identification information and associated profile information. In some examples, the server 625 may be in logical communication with a NFT server 630, which may comprise supplemental processing capabilities to associated blockchains and non-fungible token functionality.

In some aspects, the server 625 and access devices 605, 610, 615 may be able to communicate with a cohost server 640 through a communications network 620. The cohost server 640 may be in logical communication with an internal network 645 comprising network access devices 641, 642, 643 and a local area network 644. For example, the cohost server 640 may comprise a payment service, such as PayPal or a social network, such as Facebook or a dating website.

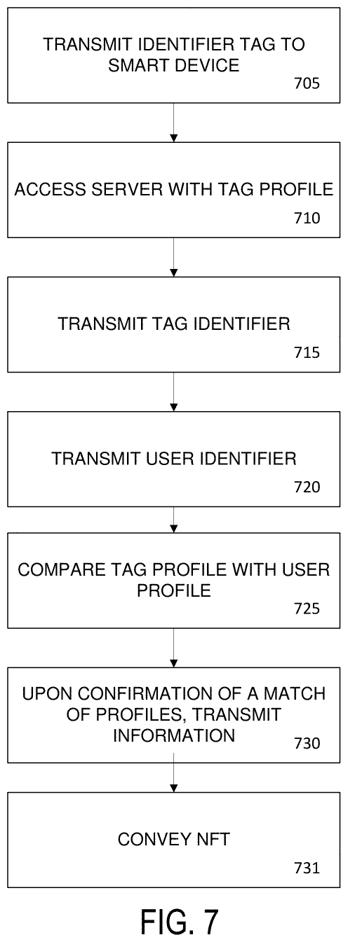

Referring now to FIG. 7, exemplary method steps for wirelessly receiving profile information, wherein the identification information may be received through a wireless transmission from a tag on a logo, are illustrated. At 705, an identifier is transmitted via BLE from a Tag to a smart device (or vice-versa). The Tag may operate as a BLE beacon. The identifier may comprise at least an IP address (or other identifier associable with an IP address, such as a URL) pointing to a server and a unique identification number. The smart device may be any computer in logical connection with a communications network and comprising a BLE transceiver. The Tag, as in other examples described herein, includes a BLE transceiver and may itself be a smart device.

At 710, the smart device accesses the server. The server may be a computer comprising a memory and may be in logical connection with a communications network. Included on the memory may be one or more tag profiles. A tag profile includes at least a unique identifier (corresponding with the identifier on the Tag in 705) and some quanta of information pertaining to a good, service, or person. For example, if the good is a bicycle that a person desires to sell, the information may include one or more of: a name of the good (e.g., bicycle), a brand name of the good, a quality of the good (e.g., “color=gray”), price, and a quantity of the good. Similarly, if the service is a car washing service, then the information may include one or more of: a name of the service (e.g., car washing service), a brand name of the service, a quality of the service (e.g., availability for a car wash), and price. If the person is someone who wishes to find individuals to date, then the information may include one or more of: a name of the person, a quality of the person (e.g., single, taller than 72 inches), and a quality of the type of individual the person wants to date (e.g., salary >$500,000).

At 715, once access with the server has been achieved, the smart device transmits the smart device may transmit the tag identifier and, at 720, user identifier. The user identifier may be associated with a user profile at 725. Upon confirmation of a match of profiles, information may be transmitted at 730. At 731, the NFT may be conveyed.

The user profile may be stored on the smart device or on the server. The user profile may comprise a unique identification number and quanta of information pertaining to the user, such as parameters indicating what the user is seeking (e.g., a bicycle, a car wash, or a date) or some qualities of the user (e.g., the user's budget is $500 or an occupation of the user).

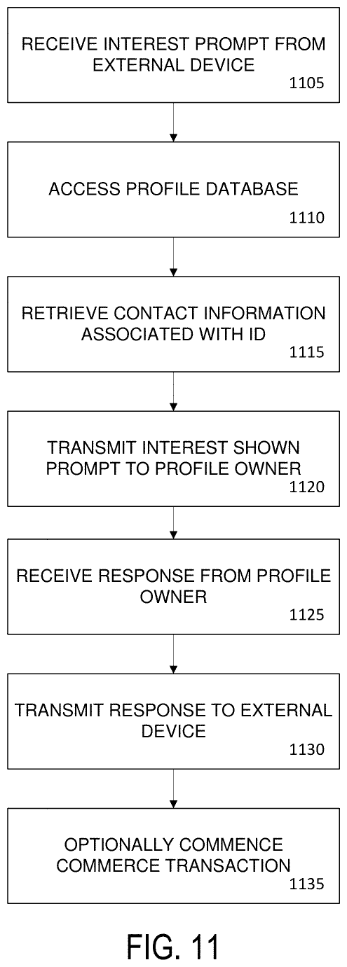

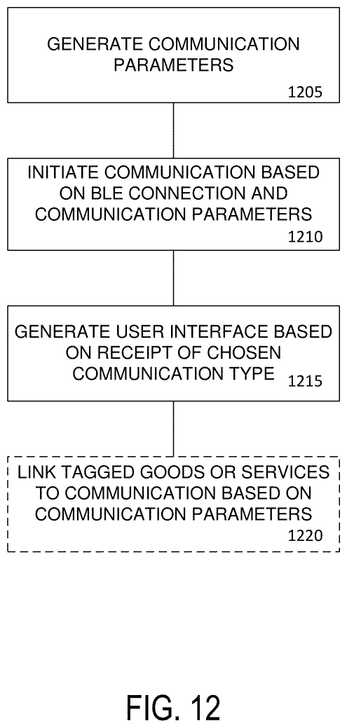

At 720, qualities of the tag profile are compared with qualities of the user profile to determine mutual interest. For example, if the user indicates an interest in a bicycle costing less than $500, and the tag profile indicates a bicycle for sale at $250, then the server may deem a match between the two profiles and initiate a communication between the user and a person associated with the bicycle. On the other hand, if the tag profile indicates a bicycle for sale at $750, then in some embodiments, no match is indicated and no communication initiates; in other embodiments, a provisional match may be indicated, and communication may be initiated to allow for negotiation. More details pertaining to the communication are explored in the discussions of FIGS. 11 and 12, infra.

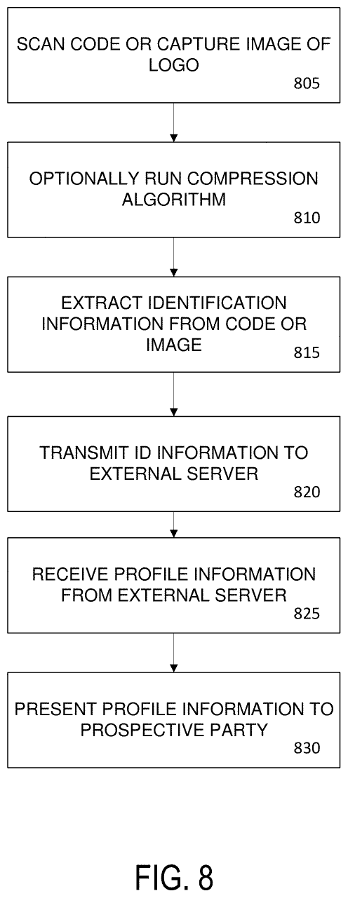

Referring now to FIG. 8, exemplary method steps for wirelessly receiving profile information, wherein the identification information may be retrieved through capture of a code or image of a logo, are illustrated. At 805, a code on a logo may be scanned, or an image of the logo may be captured, such as shown in FIG. 3. In some examples, where the identification information may be embedded in the code or image, at 810, a compression algorithm may be run on the code or image. At 815, identification information may be extracted from the code or image.

At 820, the identification information may be transmitted to an external server, such as described in FIG. 6. At 825, profile information may be received from the external server. At 830, the profile information may be presented to the prospective party.

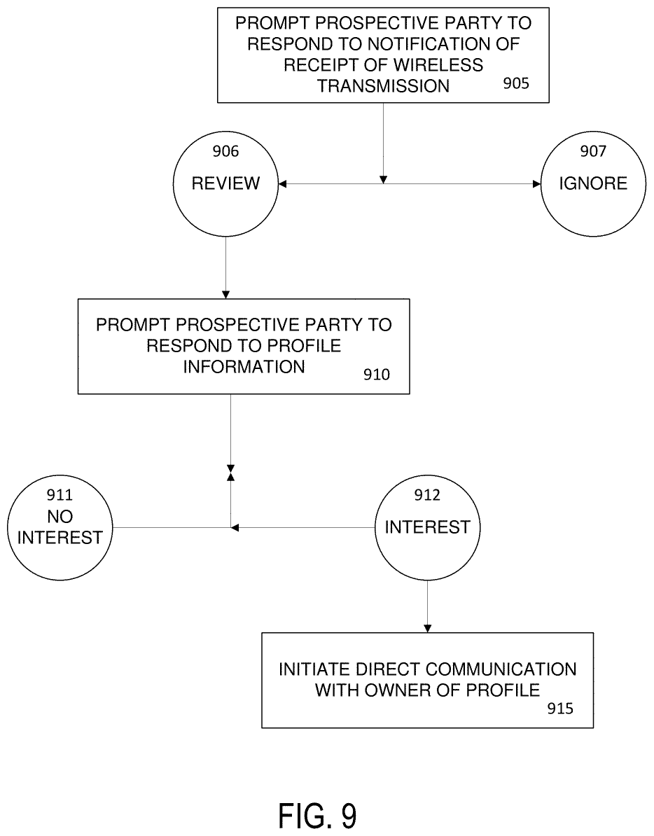

Referring now to FIG. 9, exemplary method steps for initiating direct communication between a profile owner and an Interested Party are illustrated. In some aspects, at 905, a prospective party may be prompted to respond to a notification of receipt of a wireless transmission of identification information. Where the prospective party may decide to ignore 907 the identification information, the process may terminate. Where the prospective party may decide to review the profile 906, the prospective party may be prompted to respond to the profile information at 910.

Where the prospective party may decide they are not interested 911 in the available product, service or person, the process may terminate. Where the prospective party may want to show interest 912, they may become an Interested Party, and, at 915, direct communication with the owner of the profile may be initiated.

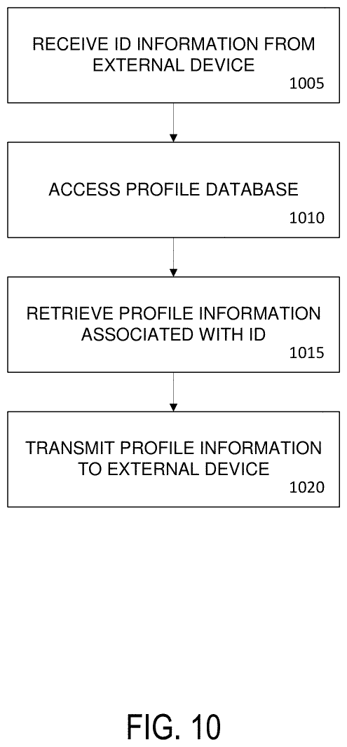

Referring now to FIG. 10, exemplary method steps for transmitting profile information to an external device are illustrated. At 1005, identification information may be received from an external device. At 1010, a profile database, such as illustrated in FIG. 6, may be accessed. At 1015, profile information associated with the identification information may be retrieved from the profile database. At 1020, the profile information may be transmitted to the external device.

Referring now to FIG. 11, exemplary method steps for allowing direct communication between a profile owner and an Interested Party are illustrated. At 1105, an interest prompt may be received from an external device. At 1110, a profile database, such as illustrated in FIG. 6, may be accessed. At 1115, contact information associated with the identification information may be retrieved.

At 1120, an interest shown prompt may be transmitted to the profile owner. The transmittal means may depend on the contact information and contact preferences provided by the profile owner. For example, in some aspects, the profile owner may prefer receiving communication from interested parties through text, whereas others may prefer communicating through a social network, such as Twitter, Facebook, or a dating website.

At 1125, a response from the profile owner may be received, and at 1130, the response may be transmitted to the external device. In some examples, the steps at 1105, 1120, 1125, and 1130 may be repeated throughout the communication between an Interested Party and a profile owner. In some examples, where the Interested Party and the profile owner may come to an agreement of terms, at 1135, a commerce transaction may be commenced.

Referring now to FIG. 12, exemplary method steps for initiating a communication based on a Bluetooth Low Energy interaction. A general goal of the method described here is facilitating a communication (potentially culminating in a transaction) based on spatial proximity, as defined by BLE, and potentially other parameters. Accordingly, at 1205, communication parameters are generated to allow a first party to communicate with a second party if one or more of the parameters are met. At least one of the first party or the second party may possess a smart device, defined as a mobile communications device comprising a BLE transceiver and in logical connection with a communications network. The parameters may include any of: a threshold spatial proximity of the first party's smart device to the second party's smart device (e.g., based on a BLE reading, a conclusion is reached that the two smart devices are less than 0.25 miles apart); a threshold spatial proximity of the first party's smart device to a Tag associated with the second party; or an interest associated with the first party, the second party, or a Tag (e.g., the first party is interested in bicycles and the Tag is coded as belonging to a bicycle; or the first and second parties are both interested in dating people with characteristics, such as age, of the respective parties). Accordingly, either the Tag or software stored on a smart device may become a beacon to alert other users that a desirable, proximate transaction may occur.

In some embodiments, the communication parameters may indicate that one or both users wish to commence peer-to-peer, anonymous, ephemeral, proximity-based messaging. This allows users to use the technology to view or contact each other anonymously while in close proximity to each other at a specific venue or location. Accordingly, in some embodiments, when one user leaves that specific location or venue, all data associated with that user may vanish from other users' devices.

At 1210, communication is initiated between the first and second parties based at least on meeting the communication parameters. In exemplary embodiments, the communication is initiated based on at least a spatial proximity between the first party and the second party (or the second party's Tag), wherein the spatial proximity is determined using at least the first party's BLE transceiver. For example, if a communication parameter requires that the first and second party be within 0.25 miles of each other, then the first party's smart device may receive a BLE transmission from the second party's smart device indicating that this threshold distance is met.

In an alternative embodiment, communication may be initiated based on the first party's proximity to a Tag. For example, if the first party indicates that the first party wishes to purchase a bicycle, and the second party has posted a Tag on, for example, a bulletin board advertising a bicycle for sale, then it may be desirable to initiate communication between the first and second parties based on the first party's spatial proximity to the Tag. This may be determined in several ways. For example, in some embodiments, the Tag may be equipped with a BLE transceiver, and thus be able to initiate a conversation just as if the BLE transmission came from the second party's smart device. In other embodiments, BLE transceivers may be strategically placed in a city, neighborhood, or other subset of spatial locations. A central server may keep an index of the locations of these BLE transceivers and associate the transceivers with Tags in the particular area.

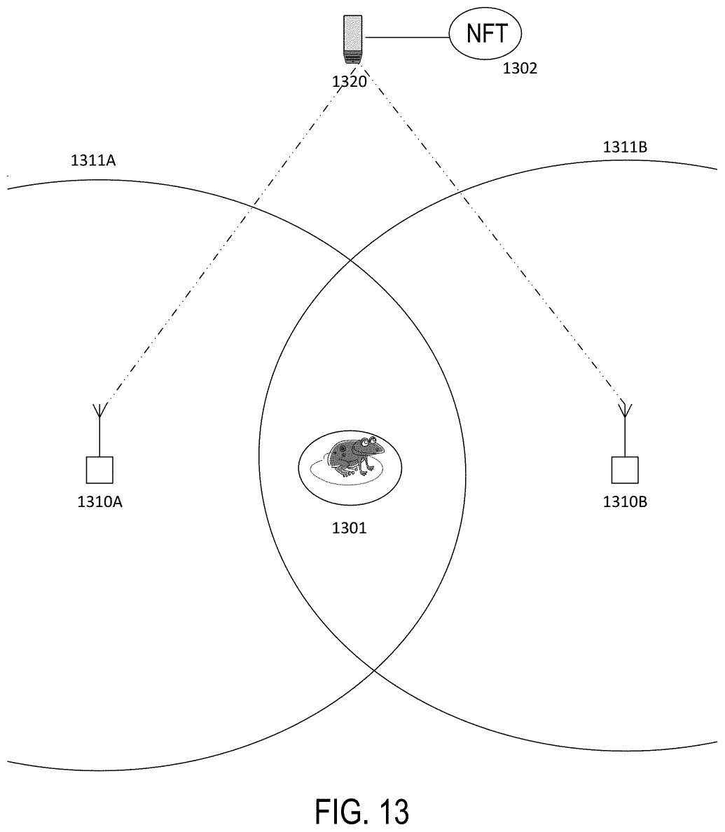

For example, referring now to FIG. 13, Tag 1301 sits in an intersection between BLE transceivers 1310A, 1310B, each having range 1311A, 1311B, respectively. Each BLE transceiver 1310A, 1310B may be in logical connection with server 1320. Server 1320 may be in logical communication with a communications network, which network also includes BLE transceivers 1310A, 1310B. Server 1320 may further comprise a memory, which memory includes various details about Tag 1301, including without limitation: an approximate geographical location, information about an item to be sold associated with Tag 1301, and information relating to previous interest in said item. In some embodiments, server 1320 may be a user's smart device, to allow for decentralized sales of products and services. If a user having a smart device with a BLE transceiver enters into range 1311A (or 1311B), and has established communication parameters that might link the user with Tag 1301 (e.g., Tag 1301 corresponds to a bicycle, and the user has indicated an interest in purchasing a bicycle), then the following flow may occur:
1) BLE transceiver 1310A detects the user's BLE transceiver, and the user's BLE transceiver detects BLE transceiver 1310A;
2) Software on the user's smart device transmits to BLE transceiver 1310A via the BLE transceiver one or more communication parameters (e.g., interest in purchasing a bicycle);
3) BLE transceiver 1310A transmits the communication parameters to server 1320;
4) Server 1320 matches a communication parameter with a quality or communication parameter associated with Tag 1301;
5) Server 1320 transmits to the user's smart device via BLE transceiver 1310A and the smart device BLE transceiver a signal indicating a desirable communication initiation;
6) Software on the user's smart device, upon receipt of the signal, sends a push notification to the user indicating that communication should be initiated.

This is an exemplary method of communicating via BLE transceivers and is not intended to be limiting.

The Server 1320 may also be in digital communication with a NFT 1302 and associated blockchain functionality to cause an exchange of one or both of ownership and control of the NFT 1302.

Referring again to FIG. 12, once a communication has been initiated by the push notification generated through the BLE transceivers, a user interface is generated at 1215 based on receipt of chosen communication type. For example, either party could indicate that their preferred mode of communication is, for example, text, voice, or video chat. Accordingly, a text-chat window may open; a voice call may be enabled between the smart devices; or if the smart devices are equipped with cameras, then a video chat may be initiated.

In some optional embodiments, at 1220, goods or services sold under a Tag may be linked into the communication. For example, at a chosen point in the communication, a user may elect to display an image associated with the goods or services. In some embodiments, a buyer may elect to purchase the goods and services directly through the interface described in 1215, while in other embodiments, the buyer and the seller may arrange further communications to determine the ultimate procedure for purchasing and selling the goods.

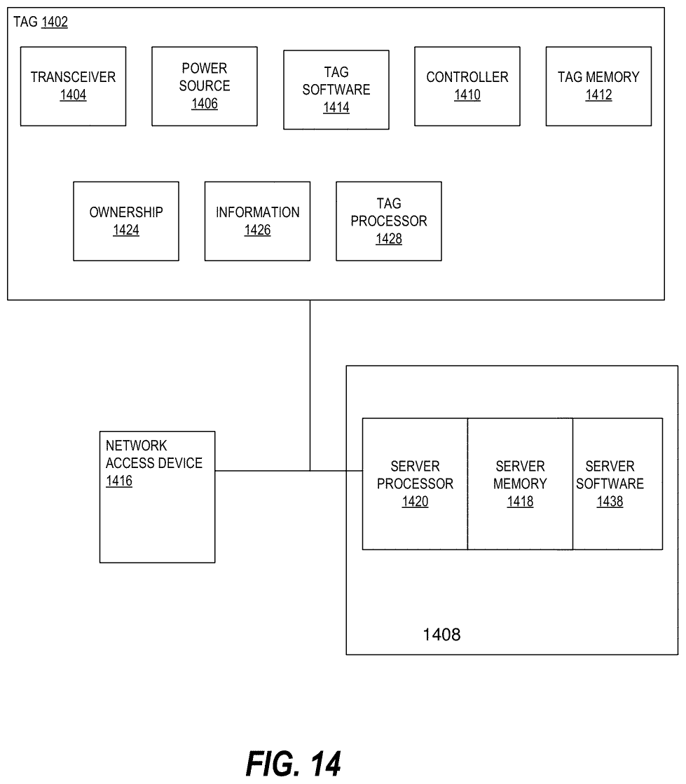

Referring now to FIG. 14, a block diagram shows a tag 1402 according to some variants of the present invention. The tag 1402 may include a transceiver 1404, a power source 1406 to provide electrical energy to the transceiver 1404. A network access device 1416 may be in logical connection with a communications network to allow communication with a server to execute server software 1408 upon demand. Also include may be tag software 1414, controllers 1410, tag memory 1412, ownership 1424 aspects, information 1426, and tag processors 1428.

The tag 1402 may also include control of the NFT in the virtual world, and the item in the physical world to an entity designated by the second party to receive the one or both of the NFT in the virtual world, and the item in the physical world. The tag 1402 may also include information associated with an available product, service, or a person. The tag 1402 may also include information associated with a desired product, service, or person.

The network access device 1408 may transmit an instruction to the server 1408. The instruction may be from a first party and include directions to transfer one or both of: information associated with the tag, and an ownership of an item associated with the tag to a second party. The server may include server processors 1420, server memory 1418, and server software 1438.

Software may be operable to receive a first unique identifier from the tag. Embodiments may also include associate the first unique identifier with a non-fungible token (NFT) in a virtual world. Embodiments may also include associate the first unique identifier with an item in the physical world. Embodiments may also include receive a second unique identifier from the first party.

Embodiments may also include compare a user profile associated with the first party with a tag profile associated with the second party. Embodiments may also include upon determination of a match between the user profile and the tag profile, transmit a signal to the first party or the second party to initiate a communication between the first party and the second party. Embodiments may also include receive an instruction from the first party to transfer one or both of ownership and control of the NFT in the virtual world, and the item in the physical world to an entity designated by the second party to receive the one or both of the NFT in the virtual world, and the item in the physical world.

In some embodiments, the tag profile may include information associated with an available product, service, or a person. A second party may be associated with the available product, service, or person in both a physical world and a virtual world. An NFT may be associated with one or more of the person, product and service.

Some variants of the present disclosure may include a method for initiating communication between a first party and a second party based on receipt of a wireless transmission, the method including the step of transmitting a tag identifier via a wireless transceiver from a tag to a smart device associated with the first party. Embodiments may also include associating the tag identifier with a non-fungible token (NFT).

Some variants may also include accessing a server including a server memory. In some embodiments, the server memory contains a tag profile associated with the second party and a user profile associated with the first party and the NFT. Embodiments may also include receiving into the tag a user identifier associated with the first party.

Some variants may also include transmitting from the tag the user identifier and the tag identifier. Embodiments may also include comparing the tag profile with the user profile. Embodiments may also include upon confirmation of a match of predefined parameters of the tag profile and the user profile, transmitting information to the smart device. Embodiments may also include transferring the NFT.

Also, one or both of the first and second parties may indicate a desired communication medium in one or both of a virtual world and a physical world. Embodiments may also include initiating a communication utilizing the indicated communication medium, such as a text message.

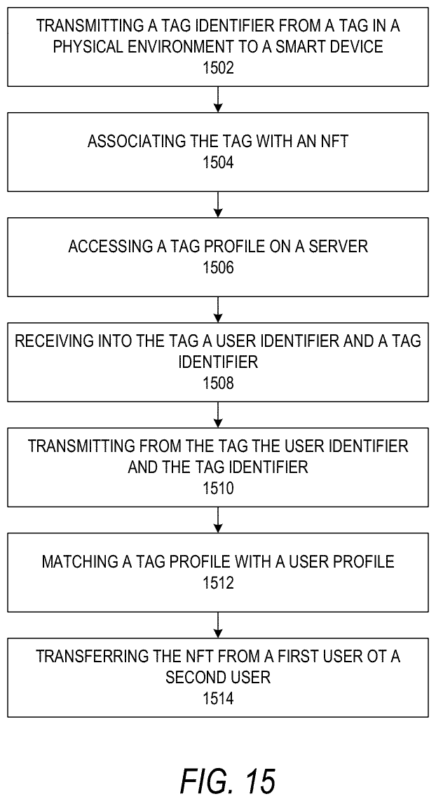

Referring now to FIG. 15 a flowchart is illustrated that shows a method for initiating communication, relating to a transfer of information descriptive of an item in a real world physical environment and an NFT in a virtual environment. At 1502, the method may include the step of transmitting a tag identifier via a wireless transceiver from a tag to a smart device associated with the first party. At 1504, the method may include the step of associating the tag identifier with a non-fungible token (NFT). In some embodiments, the server memory may contain a tag profile associated with the second party and a user profile associated with the first party and the NFT.

At 1506, the method may include the steps of receiving into the tag a user identifier associated with the first party and comparing the tag profile with the user profile. Upon confirmation of a match of predefined parameters of the tag profile and the user profile, transmitting information to the smart device. In some embodiments, the method may include the step of prompting one or both of the first and second parties to indicate a desired communication medium.

At 1508 the method may include the step of receiving into the tag a user identifier and tag identifier that may be used to identify the tag and a user deploying the tag. At method step 1510, the method may include transmitting from the tag the user identifier and the tag identifier. At step 1512 the method may include the step of matching the tag profile with a user profile. At 1514, the method may include the step of transferring the NFT.

In some embodiments, the communication medium includes one or more of: text messages. a video chat and voice chat. In some embodiments, the tag profile may include information about a good available for acquisition in the physical world that correlates with a good for sale in a virtual world and associated with an NFT.

The methods of the present invention may optionally include the steps of transmitting a tag identifier via a wireless transceiver from a tag to a smart device associated with the first party; associating the tag identifier with a non-fungible token (NFT) and transferring one or both of the NFT and the physical item from a first user to a second user.

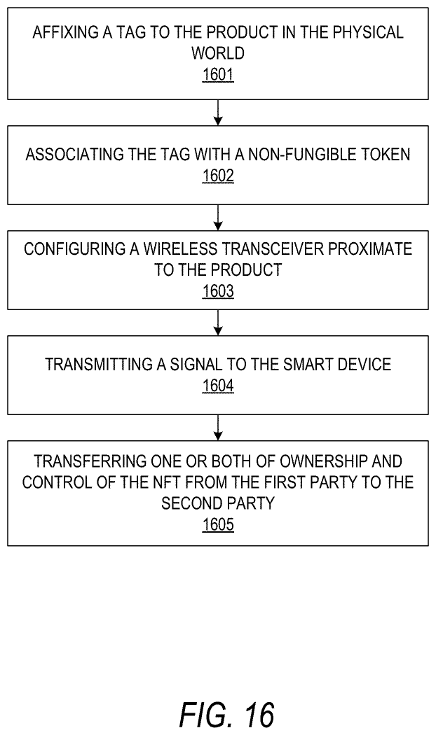

FIG. 16 is a flowchart that shows a method for initiating a product sale in both a physical environment and a virtual environment that includes at step 1601 affixing a tag to the product in the physical environment. At step 1602, the method may include associating the tag with a non-fungible token (NFT) in a virtual world. At method step 1603, the method may include configuring a wireless transceiver proximate to the product. Proximate may mean within a range such that a user may visually see both the product and the tag. In some embodiments, the BLE transceiver may have a predefined geospatial range. In some embodiments, the BLE transceiver may include a network access device in logical connection with a server.

In some embodiments, the sever may include a memory comprising a tag profile. In some embodiments, the tag profile may include one or more qualities of the product and contact information associated with the second party. In some embodiments, based upon receipt into the BLE transceiver of a BLE transmission of a smart device associated with the first party. In some embodiments, the BLE transmission may include a user identifier, transmitting a communication to the server comprising the user identifier.

At 1604, the method may include the step of, based upon receipt into the BLE transceiver of a signal from the server indicating a match between a profile of the first party and the second party, transmitting a signal to the smart device associated with the first party to initiate a communication. At 1605, the method may include the step of transferring one or both of ownership and control of the NFT from the first party to the second party.

In some embodiments, the server may further include a user profile associated with the first party. In some embodiments, the user profile may include one or more qualities of a product desired by the first party. In some embodiments, one or both of the user profile and the tag profile may include a desired communications medium. In some embodiments, the desired communications medium includes one or more of: text messages, video chat and voice chat.

A number of examples of the present disclosure have been described. While this specification contains many specific implementation details, there should not be construed as limitations on the scope of any disclosures or of what may be claimed, but rather as descriptions of features specific to particular examples of the present disclosure.

Certain features that are described in this specification in the context of separate examples can also be implemented in combination in a single embodiment. Conversely, various features that are described in the context of a single embodiment can also be implemented in combination in multiple examples separately or in any suitable sub-combination. Moreover, although features may be described above as acting in certain combinations and even initially claimed as such, one or more features from a claimed combination may, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the examples described above should not be understood as requiring such separation in all examples, and it should be understood that the described program components and systems can generally be integrated together in a single software product or packaged into multiple software products.

While the disclosure has been described in conjunction with specific examples, it is evident that many alternatives, modifications, and variations will be apparent to those skilled in the art in light of the foregoing description. Accordingly, this description is intended to embrace all such alternatives, modifications, and variations as fall within its spirit and scope.

Although shown and described in what is believed to be the most practical and preferred examples, it may be apparent that departures from specific designs and methods described and shown will suggest themselves to those skilled in the art and may be used without departing from the spirit and scope of the disclosure. The present disclosure is not restricted to the particular constructions described and illustrated, but should be constructed to cohere with all modifications that may fall within the scope of the appended claims.

What is claimed is:

1. A tag capable of facilitating communication between a first party and a second party, wherein the tag comprises:
a transceiver;
a power source to provide electrical energy to the transceiver; and
a network access device in logical connection with a communications network to allow communication with a server, wherein the server comprises:
a server memory;
a server processor;
a server network access device in logical connection with the communications network; and
server software executable on demand, wherein the server software is operable to:
receive a first unique identifier from the tag;
associate the first unique identifier with a non-fungible token (NFT) in a virtual world;
associate the first unique identifier with an item in the physical world;
receive a second unique identifier from the first party;
compare a user profile associated with the first party with a tag profile associated with the second party; and
upon determination of a match between the user profile and the tag profile, transmit a signal to the first party or the second party to initiate a communication between the first party and the second party; and
receive an instruction from the first party to transfer one or both of: ownership and control of the NFT in the virtual world, and the item in the physical world to an entity designated by the second party to receive the one or both of the NFT in the virtual world, and the item in the physical world.

2. The tag of claim 1, wherein the tag profile comprises information associated with an available product, service, or a person, and wherein the second party is associated with the available product, service, or person.

3. The tag of claim 1, further comprising a tag memory containing the first unique identifier.

4. The tag of claim 1, wherein the user profile comprises information associated with a desired product, service, or person.

5. The tag of claim 1, wherein the user profile is stored on the server and the entity designated by the second party to receive the one or both of the NFT in the virtual world, and the item in the physical world is the second party.

6. The tag of claim 3, further comprising a tag processor and tag software executable on demand operative to:
receive a wireless transmission from a smart device associated with the first party, wherein the wireless transmission comprises the second unique identifier; and
transmit the first unique identifier and the second unique identifier to the server.

7. The tag of claim 6, wherein the tag software is further operable to transmit to the smart device a communication from the second party upon receipt of the signal from the server.

8. A method for initiating communication between a first party and a second party based on receipt of a wireless transmission, the method comprising the steps of:
transmitting a tag identifier via a wireless transceiver from a tag in a physical environment to a smart device associated with the first party;
associating the tag identifier with a non-fungible token (NFT);
accessing a server comprising a server memory, wherein the server memory contains a tag profile associated with the second party and a user profile associated with the first party and the NFT;
receiving into the tag a user identifier associated with the first party;
transmitting from the tag the user identifier and the tag identifier;
comparing the tag profile with the user profile;
upon confirmation of a match of predefined parameters of the tag profile and the user profile, transmitting information to the smart device; and
transferring the NFT.

9. The method of claim 8, further comprising the steps of:
prompting one or both of the first and second parties to indicate a desired communication medium; and
initiating a communication utilizing the indicated communication medium.

10. The method of claim 9, wherein the communication medium comprises text messages.

11. The method of claim 9, wherein the communication medium comprises a video chat.

12. The method of claim 9, wherein the communication medium comprises a voice chat.

13. The method of claim 9, wherein the tag profile comprises information about a good for sale.

14. The method of claim 13, wherein the user profile comprises information about a good the first party wishes to purchase.

15. A method for initiating a product sale communication between a first party and a second party based on receipt of a wireless transmission, the method comprising the steps of:
affixing a tag to the product in the physical world;
associating the tag with a non-fungible token (NFT) in a virtual world;
configuring a BLE transceiver proximate to the product, wherein the BLE transceiver has a predefined geospatial range, and wherein the BLE transceiver comprises a network access device in logical connection with a server, wherein the server comprises a memory comprising a tag profile, and wherein the tag profile comprises one or more qualities of the product and contact information associated with the second party;
based upon receipt into the BLE transceiver of a BLE transmission of a smart device associated with the first party, wherein the BLE transmission comprises a user identifier, transmitting a communication to the server comprising the user identifier;
based upon receipt into the BLE transceiver of a signal from the server indicating a match between a profile of the first party and the second party, transmitting a signal to the smart device associated with the first party to initiate a communication; and
transferring one or both of ownership and control of the NFT from the first party to the second party.

16. The method of claim 15, wherein the server further comprises a user profile associated with the first party, wherein the user profile comprises one or more qualities of a product desired by the first party.

17. The method of claim 16, wherein one or both of the user profile and the tag profile include a desired communications medium.

18. The method of claim 17, wherein the desired communications medium comprises text messages.

19. The method of claim 17, wherein the desired communications medium comprises a video chat.

20. The method of claim 17, wherein the desired communications medium comprises a voice chat.
